(19) United States
(12) Patent Application Publication
(10) Pub. No.: US 2021/0151017 A1
(43) Pub. Date: May 20, 2021

(54) Solfaphone

(71) Applicant: William H.T. La, Stockton, CA (US)

(72) Inventor: William H.T. La, Stockton, CA (US)

(21) Appl. No.: 17/005,108

(22) Filed: Aug. 27, 2020

Related U.S. Application Data
(60) Provisional application No. 62/922,790, filed on Aug. 27, 2019.

(51) Int. Cl. G10H 1/00; G06F 3/01; G10G 1/02; G10H 1/34; G10G 1/04; G09B 15/02

(52) U.S. Cl. CPC G10H 1/0008; G06F 3/016; G10G 1/02; G10H 1/34; G10H 2220/241; G09B 15/023; G10H 2220/126; G10H 2220/391; G10G 1/04

(57) ABSTRACT

A 128-note MIDI-range monophonic musical keyboard instrument (100) includes an octave keypad (106) with eleven keys arranged in an analog clock face format for octave selection with the thumb of one hand, a pitch keypad (108) with twelve pitch keys similarly disposed in a clockface arrangement around a central omnivalent thirteenth key (128), enabling the nondisjointed sounding of nonadjacent notes with the thumb of the other hand. Spatial manipulation of the device, such as tilting and jabbing, can switch octaves and activate other functions, enabling one-handed operation and overcoming small-screen space limitation. Aside from producing typical electronic piano or synthesizer sounds, the device can sing in human voice an extended monosyllabic solfege covering all twelve pitch families of the common chromatic 12-tone even-tempered scale. A pictograph-based music notation (156) mirrors the circular geometry of the pitch and octave keyboards and facilitates the intuitive reading and playing of a melody.

### CROSS-REFERENCE TO RELATED APPLICATION

This application claims the benefit of provisional application Ser. No. 62/922,790, filed Aug. 27, 2019 by the present inventor.

### BACKGROUND AND PRIOR ART

The following is a tabulation of some prior art that presently appears relevant:

U.S. Patents

| Patent Number | Kind Code | Issue Date | Patentee |
|---|---|---|---|
| 10,235,983 | B2 | 2019 Mar. 19 | Strachan |
| 10,134,300 | B2 | 2018 Nov. 20 | Koren et al. |
| 9,997,147 | B2 | 2018 Jun. 12 | Kasahara |
| 9,679,542 | B2 | 2017 Jun. 13 | Parsons et al. |
| 9,196,171 | B2 | 2015 Nov. 24 | Nguyen |
| 8,981,197 | B1 | 2015 Mar. 17 | Alsultan |
| 8,674,207 | B1 | 2014 Mar. 18 | Seymour |
| 8,445,767 | B2 | 2013 May 21 | Brow et al. |
| 8,426,719 | B2 | 2013 Apr. 23 | Shim |
| 8,207,435 | B2 | 2012 Jun. 26 | Charles |
| 7,790,972 | B2 | 2010 Sep. 7 | Stewart |
| 7,659,473 | B2 | 2010 Feb. 9 | Ramstein |
| 6,245,981 | B1 | 2001 Jul. 12 | Smith |
| 6,191,349 | B1 | 2001 Feb. 20 | Flam |
| 5,777,248 | | 1998 Jul. 7 | Campbell |
| 4,733,591 | | 1988 Mar. 29 | Kaneko et al. |

U.S. Patent Application Publications

| Publication Nr. | Kind Code | Publ. Date | Applicant |
|---|---|---|---|
| 20150221231 | A1 | 2015 Aug. 6 | Ua-Apithorn |

Nonpatent Literature Documents
GUIDO Music Notation, https://en.wikipedia.org/wiki/GUIDO_music_notation, retrieved 2020 Aug. 27.

Homo Sapiens shares with the higher animals the ability to derive pleasure from basic biological and social functions such as feeding, grooming, and mating. The joy of singing or whistling is shared with fewer animals. Creating music beyond vibrating body parts, i.e., by playing a tonal instrument, is a uniquely human capacity for mirth. It has been said that making music is a full-body exercise for the brain. To sing and make music at the same time therefore engages all of one's soul, mind, and body. However, for a variety of reasons, few of us regularly partake in this evolutionary advance which is both a mode of communication and a source of happiness and healing. There lacks a means for the uninitiated user of any cultural background and educational level to share a melody and play music of decent quality at nominal cost with negligible training using a readily available implement. No instantly learnable and permanently available universal musical system exists that allows an average person to create, communicate, and perform a tune in an intuitive manner whenever and wherever the inclination arises. Many of us are therefore missing out on one of the highest forms of cultural expression in our otherwise advanced civilization.

A musical keyboard normally includes a set of finger-operable keys that sound consecutive notes of a musical scale, enabling a performer to play a musical composition on the instrument, possibly using all ten fingers simultaneously. A conventional piano clavier typically has 88 white and black keys covering seven octaves plus a minor third, producing notes A0 to C8. Portable electronic keyboards have a smaller number of keys and cover fewer octaves, usually from two to five. Pianos and keyboards are wonderful musical tools used by those who can fit them in their budget and lifestyle. Many others could enjoy the manual performance of a simple composition on a simple-minded instrument if such could be readily acquired and learned. Mobile smart electronic devices, already permanently carried or worn by a substantial portion of humankind, present a fresh opportunity, with the trivial download of an app, to provide such functionality at any time and in any place. Their potential is currently unrealized, and phones are not widely used for on-the-go musicmaking.

The inherent problem in implementing a keyboard on a smartphone is the lack of “real estate” on the touchscreen. Many piano and keyboard offerings targeted at mobile phones can be found in the app stores, but most are not practical, even for tiny fingers. Some present a small number of keys corresponding to one or two octaves. In others, the screen serves as a small window on a larger set of octaves, with the window slidable up and down the range through a separate maneuver. Even a smartwatch has been provided with a one-octave, two-row keyboard. None of these solutions offers a way to operate a mobile device in the manner of a regular keyboard, with ten fingers comfortably playing notes and chords, melodies and harmonies, or even with one finger playing a tune smoothly over more than a couple of octaves. There is therefore currently no particularly successful method for musical keyboarding on a handheld touchscreen.

There are also tuning apps that present the twelve pitch families of a chromatic octave arranged in a circular pattern, with separate buttons for switching to higher and lower octaves. These products are intended for providing reference pitches for the specific purpose of tuning acoustic instruments. A device of this type could conceivably be used for sounding a melody monophonically, albeit disjointedly. The resulting performance would be akin to playing a piano one note at a time with one finger, in a hunt-and-peck fashion. With this configuration, more than one finger attempting to hit the note keys might lead to an awkward digital entanglement.

Aside from the limited size of a handheld mobile device that precludes the practical implementation of a conventional keyboard, a separate issue that inhibits the wide dissemination of performative musical literacy is the steep learning curve presented by music theory, and particularly traditional musical notation. Even in possession of a straightforward instrument, the average person must still learn sheet music sight-reading along with the intricacies of quarter and eighth notes, scales and clefs, naturals and accidentals, sharps and flats, and staff steps that denote one whole tone in some cases and one semitone in others.

Two factors therefore impede the widespread development of musical skill among the general population as made possible by the ubiquity of mobile electronics: the limited screen space of these devices, and the unfriendly user interface of the traditional music notation.

Various aspects of some embodiments are present in separate methods and articles of the current art, but no existing method or article combines these aspects and further innovations into a practical solution for the problem at hand. Many circular keyboard arrangements are in existence. Campbell shows in U.S. Pat. No. 5,777,248 (1998) a tuning device with note and octave indication elements arranged in a clock face format. Stewart shows in U.S. Pat. No. 7,790,972 (2010) a circular keyboard including peripheral keys and a central key, wherein the central key can either provide a shift function or play a chordal role like the other keys. Stewart also shows the provision of a plurality of such keyboards for the different fingers of a hand, yielding an instrument having a plurality of manuals. Charles, responding to the need for a common musical language with the capacity to score music in a form that is understandable to trained and untrained musicians alike, proposes in U.S. Pat. No. 8,207,435 (2012) a special tablature notation, and shows a steel pan construction with multiple octaves disposed in concentric annular bands, or rings, of indicia. Seymour shows in U.S. Pat. No. 8,674,207 (2014) a polyphonic instrument with a circular keyboard arranged in concentric octave bands. Alsultan shows in U.S. Pat. No. 8,981,197 (2015) a polyphonic computer input device in the form of a circular keypad representing the circle of fifths. Parsons et al. show various circular keyboard instruments in U.S. Pat. No. 9,679,542 (2017). None of the above arrangements provides for fluent melody-sounding with one finger.

Solfege-singing instruments have been described. Kaneko et al. in U.S. Pat. No. 4,733,591 (1988), Flam in U.S. Pat. No. 6,191,349 (2001), Kasahara in U.S. Pat. No. 9,997,147 (2018), and Koren et al. in U.S. Pat. No. 10,134,300 (2018) show electronic devices and methods for human-like machine voicing of MIDI notes in solfege syllables. Flam, as well as Koren et al., allow for multisyllabic note names such as C #while the other inventors ignore this inconvenient complication. None of these inventions explicitly addresses the desirability of the monosyllabic voicing of all twelve chromatic pitch classes, as no definitive nomenclature is currently in common use for uniquely identifying the black notes irrespective of scale traversal direction, ascending or descending.

Many schemes have been advanced to simplify musical notation and make it more accessible. For example, an alphanumeric encoding method proposed by Nguyen in U.S. Pat. No. 9,196,171 (2015) uses note words that are simpler, less abstract, and more intuitive than the standard notation. However, each note element still incorporates duration information, impeding its cognitive processing by the novice sight reader. The GUIDO music notation has the same problem. A graphical encoding method by Ua-Apithorn in U.S. patent application 20150221231 (2015) uses a color- or line pattern-dependent dozenal, or Base-12, radial representation which is akin to a circular mapping of the traditional staves, complete with chords and notehead morphologies, resulting in a display of comparable visual complexity and nontrivial decipherability. No simplified system has offered a sufficient advantage to supplant the established staff notation and gain wide use, to the detriment of casual musicmakers and amateur tune composers.

Other articles of the art teach ancillary features of some embodiments. Smith shows in U.S. Pat. No. 6,245,981 (2001) a circular mechanical slide rule-type pitch transposer. Brow et al. show in U.S. Pat. No. 8,445,767 (2013) a piano roll-like display method that obviates the need for the user to mentally map musical notation to instrument keys, minimizing the path complexity for the musician's eye-hand coordination in going from visual musical cues to key activations. Strachan teaches in U.S. Pat. No. 10,235,983 (2019) a rhythm system with time circle, peripheral time increments, tempo control, and loop selector. Ramstein, in U.S. Pat. No. 7,659,473 (2010), applies haptic feedback and Shim, in U.S. Pat. No. 8,426,719 (2013), applies accelerometry to musical instruments. No innovative synthesis of these prior-art capabilities exists to provide an accessible and available musical tool.

### SUMMARY

Aimed at establishing a universal musical system for non-professional players, embodiments presented here are motivated by two principles. First, the functionality of a polyphonic keyboard cannot be ported to the small screen of a pocket-sized device. Second, the versatility and comprehensiveness of the conventional musical notation are not necessary for a casual performer to learn and play a simple tune. Embodiments leverage two basic human capabilities, the ability to sing and the ability to read an analog clock, to develop a third skill: playing a tonal instrument. A keyboard embodiment provides a 12-tone clocklike pitch keyboard collaborating with a clocklike octave selector. The pitch keypad includes a thirteenth, centrally located omnivalent key, to provide for smooth transition between notes. This keyboard, played with both thumbs, can reproduce the sounds of acoustic instruments along with synthetic waveforms, as a conventional electronic keyboard can. In addition, it can sing the solfege by having the note keys voice their own names at the proper pitches, helping the user memorize a melody. We thus refer to this instrument as a solfaphone. A musical notation embodiment leverages the universal recognition of an analog clock dial by providing 12-position clockface-like graphic note symbols. Another notation embodiment provides simple alphanumeric note-words based on an expanded, unambiguous, monosyllabic solfege.

Advantages of some musical language embodiments are ease of production, transmission, and recognition. Advantages of some musical instrument embodiments are ease of importation onto a smart device and ease of performance. Advantages of some language and instrument embodiments collectively are commonality of geometry and shared paradigm with the clockface. A pedagogic advantage of an embodiment's ability to sing solfege in unison with the performer is the creation in the student of a self-reinforcing loop of eye-hand-ear-mouth coordination that engages a multitude of neurological pathways and fast-tracks the simultaneous learning of singing and instrument playing, as well as the retention of new works.

### DRAWINGS—FIGURES

FIG. 1: Phone usage

FIG. 2: Phone embodiment

FIGS. 3A-D: Octave selection process

FIGS. 4A-F: Pitch selection process

FIGS. 5A-D: Trill process

FIGS. 6A-F: Transposition process

FIGS. 7A-D: Scale-making process

FIGS. 8A-F: Scale structures

FIG. 9: Diatonic scale modes

FIG. 10: Select diatonic scale keys

FIG. 11: Pentatonic scale modes

FIG. 12: Select pentatonic scale keys

FIGS. 13A-C: Music notations

FIG. 14: Guidograms for Hh, Om, and La

FIG. 15: Guidograms for Do and 9So

FIG. 16: Guidograms for Octave #3

FIG. 17: Guidograms for Octave #4

FIG. 18: Guidograms for Octave #5

FIG. 19: Extended phone embodiment

FIGS. 20A-C: Music display

FIGS. 21A-F: Note and piano roll display

FIGS. 22A-E: Tempo and rhythm display

FIG. 23A-B: Tablet usage

FIG. 24: Tablet embodiment

FIGS. 25A-B: Watch usage

FIGS. 26A-B: Watch embodiment

FIGS. 27A-D: Control by tilting

FIGS. 28A-D: Control by jabbing

### DRAWINGS—REFERENCE NUMERALS

100—Phone embodiment
102—Phone body
104—Phone touchscreen
106—Octave keypad
108—Pitch keypad
110—Settings button
112—Octave keys
114—Octave indicia
116—Octave highlight
118—Octave keypad core
120—Left thumb
122—Pitch keys
124—Solfege pitch indicia
126—Letter pitch indicia
128—Omni key
130—Right thumb
132—Pitch highlight
134—Trill zone
136—Trill zone boundary
138—Touch contact point
140—Provisional pitch highlight
142—Right index finger
144—Key gap
146—White keys
148—Black keys
150—Diatonic scale structure
152—Pentatonic scale structure
154—Guidotype
156—Guidogram
158—Guidogram perimeter
160—Guidogram index
162—Guidogram Om sign
164—Guidogram octave indicator
166—Guidogram pitch indicator
168—Sheet music display
170—Note and piano roll display
172—Tempo and rhythm display
174—Sheet music display frame
176—Cursor
178—Lyrics
180—Progress bar
182—Play/pause button
184—Note dial
186—Piano roll ring
188—Note dial perimeter
190—Note dial indicia
192—Note dial octave indicator
194—Note dial pitch indicator
196—Piano roll perimeter
198—Octave graphic element
200—Pitch graphic element
202—Tempo dial
204—Rhythm ring
206—Tempo dial perimeter
208—Tempo indicia
210—Tempo indicator
212—Tempo readout
214—Rhythm ring perimeter
216—Rhythm indicia
218—Tablet embodiment
220—Slider controls
222—Pad buttons
224—Tempo buttons
226—Recorder buttons
228—Accompaniment buttons
230—Watch embodiment
232—Combination octave/pitch keypad
234—Peripheral octave indicia
236—Peripheral octave highlight
238—Pitch supplemental highlight
240—Octave indicator
242—Level indicator
244—Pending octave indicator
246—Virtual button
248—Virtual button ring in xy plane
250—Virtual button ring in yz plane
252—Virtual button ring in zx plane

### DETAILED DESCRIPTION

The subject matter relates generally to keyboard musical instruments. As used herein, the term “horomorphic” denotes geometric similarity to an analog clockface indicating time in a 12-hour cycle, divided into twelve equal angular sectors which may be implicitly or explicitly delineated, with a full or partial complement of indicia in the hour positions.

### Phone Embodiment

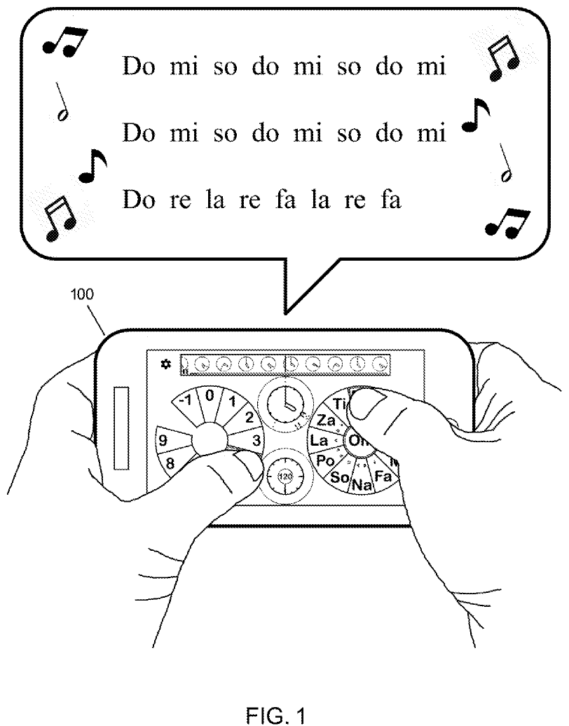

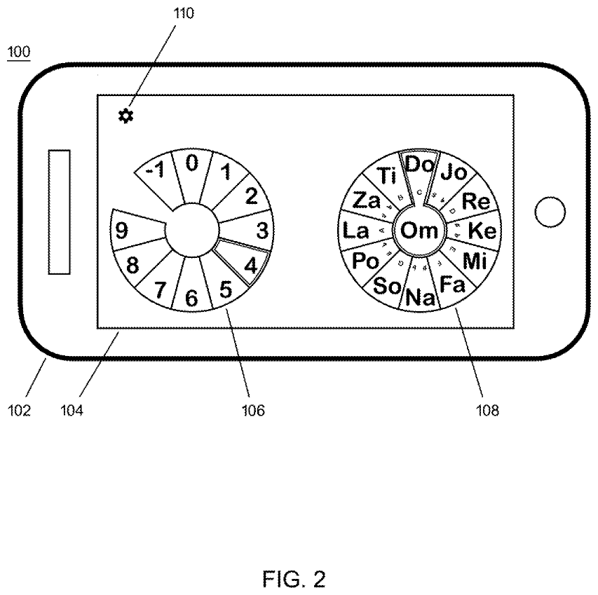

FIG. 1 shows an embodiment 100 based on a smartphone serving as electronic processing means that sings in solfege when played with the user's two thumbs. FIG. 2 shows details of phone 100 with a basic set of features, including a body 102 and a touchscreen 104 displaying octave selection keyboard or keypad 106 serving as an octave selection means, pitch family selection keyboard or keypad 108 serving as a pitch selection means, and settings button 110 serving as an option selection means. A note is played by setting the value of its octave property with octave keypad 106 and activating its pitch family key in pitch keypad 108.

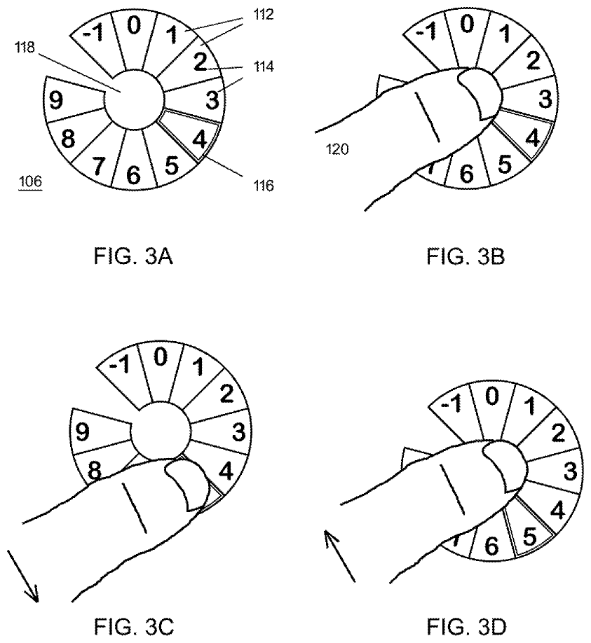

FIG. 3A shows details of horomorphic octave keypad 106 including an annular arrangement of eleven contiguous octave selection keys 112. The ring of octave keys is discontinuous and has a gap at the ten o'clock position. Each key 112 is marked with an octave index 114. The eleven circularly arranged indicia 114 collectively form a discontinuous circle of octave numbers respectively displaying the eleven numerals from “−1” to “9” starting at the eleven o'clock position in ascending numerical order in the clockwise direction and ending at the nine o'clock position. Octave keys 112 act as radio buttons and at any given time one and only one of them is active, shown here as the key for Octave #4, marked with an active octave highlight 116. The central core 118 is not responsive and serves as a neutral resting point for the instrument player's octave-selecting finger. FIGS. 3B, 3C and 3D show the process of selecting a note's octave property, in this case changing from Octave #4 to Octave #5. Starting in the initial state with the Octave #4 key being active, the player's left thumb 120 is brought into contact with the touchscreen over core 118 (FIG. 3B). The thumb then slides toward the Octave #5 key and activates it, simultaneously deactivating the Octave #4 key (FIG. 3C). Thumb 120 then returns to the neutral position, leaving the Octave #5 key activated (FIG. 3D). This does not immediately change the characteristics of a note being played. Only when a pitch selection event is next performed on pitch keypad 108 does the new octave value, “5” in this case, get applied to the new note. In the typical performance of a tune, thumb 120 uses core 118 as the home position, returning to it after each strike of a peripheral key. Haptic feedback may be applied to help finger 120 gain the correct central positioning. For a player familiar with the appearance of an analog clock or watch, little training is required to accurately hit the desired octave key with the left thumb from this home vantage without looking at the screen.

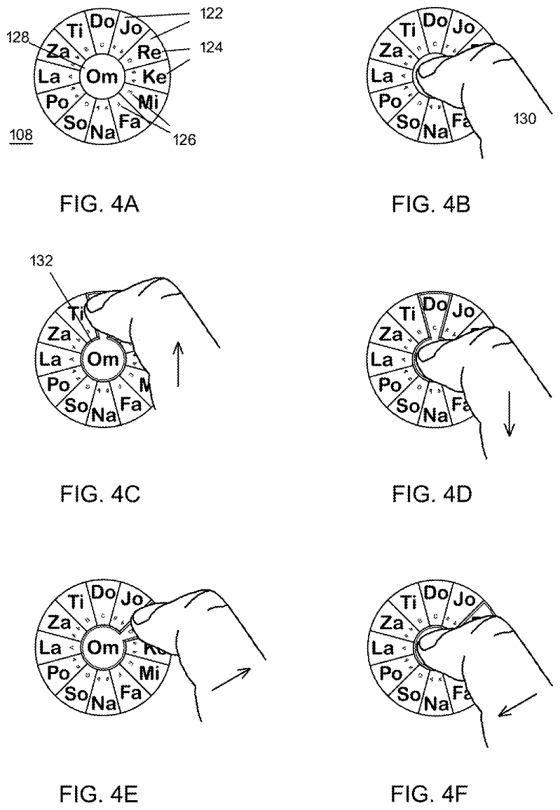

FIG. 4A shows details of horomorphic pitch family or pitch class selection keypad 108 including twelve annularly arranged pitch class selection keys 122 which act as momentary, normally open switches, in the usual wiring equivalent of a physical electronic keyboard. Pitch keys 122 are collectively marked with a distal circular arrangement of solfege pitch indicia 124 and a concentric proximal circle of conventional letter pitch indicia 126. Indicia 124 collectively form a continuous circle of solfege names respectively displaying the twelve alphabetic words Do, Jo, Re, Ke, Mi, Fa, Na, So, Po, La, Za, and Ti starting at the twelve o'clock position in a clockwise direction. These names are adaptations of the traditional solfa words Ut, Re, Mi, Fa, Sol, and La devised by Guido of Arezzo in the eleventh century CE, later modified to Do, Re, Mi, Fa, Sol, La and Si or Ti, for the 7-note diatonic scale, represented by the white keys on a traditional clavier. These are augmented with new names Jo, Ke, Na, Po, and Za for the 5-note pentatonic scale, represented by the clavier's black keys. Whereas in traditional solfege practice these five “accidentals” are assigned derived designations that differ among ascending and descending scales, the present proposed naming system ensures that each pitch family of the twelve-tone equal-tempered chromatic scale, or 12-TET, gets first-class status and receives a distinct two-letter name with a unique initial consonant, setting the foundation for a standardized and simplified alphanumeric musical notation system. Indicia 126 represent the traditional pitch names C, C #/Db, D, D #/Eb, E, F, F #/Gb, G, G #/Ab, A, A #/Bb, and B, with C being paired with Do in the twelve o'clock position. For simplicity, 2-name pitches such as C #/Db are shown simply as “#b”, the positional context providing disambiguation. Core 128, also a responsive area, marked with “Om” as an abbreviation of “omni” or “omnivalent”, constitutes the novel thirteenth key of pitch pad 108, and serves to smooth the acoustic transition between nonadjacent notes as explained below.

FIGS. 4B to 4F show the process of selecting a note's pitch family property using pitch selector 108, such as for sounding note Do followed by sounding note Re. Starting in the initial state with no key being active, the player's right thumb 130 is brought into contact with the touchscreen over Om key 128 (FIG. 4B). Finger 130 then slides toward Do and activates it (FIG. 4C), simultaneously activating Om, both keys now forming a united active pair fulfilling the same function and identified by the shared active pitch highlight 132, sounding note C. If the octave selector key #4, for example, is currently active, then the specific pitch generated is C4: octave #4, pitch class C. Finger 130 then returns to the Om position while maintaining contact with the touchscreen (FIG. 4D), sustaining note C4. The thumb next moves to strike key Re (FIG. 4E), which sounds note D4 if the octave setting has not been changed. Simultaneously, Om disengages with Do and unites with Re. The finger returns to Om (FIG. 4F), sustaining note D4. The Om key thus works by switching identity, becoming the functional extension of any activated peripheral key, serving as a transit hub which is adjacent to all twelve pitch keys, thereby ensuring an unbroken acoustic flow from one note to the next. Following the situation shown in FIG. 4D, a return of thumb 130 to Do would result in a fresh attack of the same note. In the typical performance of a tune, the right thumb uses Om as the home position, returning to it after each strike of a peripheral key, its motion exhibiting a succession of jabs in the direction of the desired notes. As with octave selector 106, haptic guidance may assist finger positioning in pitch selector 108. A melody may be played smoothly without the finger breaking contact with the touchscreen. For silent breaks, the finger may be lifted or moved off the bounds of the keypad. This device being a monophonic instrument, only one note is sounded at a time and any additional contact point made within the keypad during a performance is ignored, except during an adjustment maneuver with a well-defined pattern, as used in the transposition and scale-making features described below.

The octave keypad 106 and pitch keypad 108 collaboratively enable the user to play a melody monophonically in a nondisjointed manner. delivering fluent musicality. The available frequency gamut encompasses the whole 128-note MIDI range. The lowest note provided is MIDI note #0, of frequency 8.176 Hz, corresponding to C-1 in piano notation, or −1Do in the present system. The highest is MIDI note #127, 12.544 kHz, corresponding to G9 or 9So. The frequencies are based on the standard of 440 Hz for MIDI note #69, or A4. The notes may possess various envelope and timbre properties, from simple sine, square, triangular, and sawtooth shapes to more complex sound signatures of various acoustic instruments, such as the piano, violin, and flute, or other synthesized waveforms. Settings button 110 enables navigation through customary dropdown menus for sound timbre selection and other functions, such as switching the positions of keypads 106 and 108 for lefthanded users. The monophonicity of device 100 represents a departure from the norm set by electronic organs and other keyboard musical instruments but makes it simple and readily learnable.

As another novel aspect of embodiment 100, for the purpose of enhancing its pedagogic and entertainment values, the notes may be sung by the device with their solfa names in a human voice, as made possible by the naming convention proposed here. A more advanced feature set may include provisions for trilling, operation with a small-size screen, transposition, scale construction, note readout and piano roll, metronome and rhythm, sheet music display, and various additional functions as described below. Device 100 can be operated as a standalone instrument, or as a controller for an external MIDI device such as a computer or an electronic piano, or as a member of an ensemble of units in remote wired, wireless, or online coordination. The software or firmware coding of these features on the electronic or computer processing means is within the capability of an engineer knowledgeable in the art of app programming. Current web technologies enable platform-independent implementation as a purely browser-based progressive web app (PWA) leveraging built-in resources such as local storage and networking, and APIs such as HTML5 Canvas, WebGL, Web Animations, Web Audio, Web Speech, and Web MIDI for rendering the graphics, music, and humanoid vocals with prosody control.

### Trilling

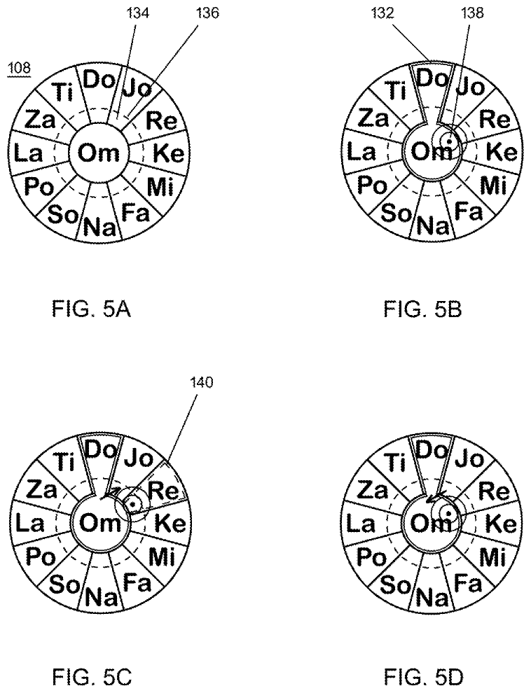

FIGS. 5A to 5D show an aspect that enables trilling. On a regular polyphonic keyboard, a trill involves the rapid alternation of two notes performed with two fingers. If the notes are one semitone apart, such as Mi and Fa, this maneuver can also be readily accomplished on pitch keypad 108 with the playing finger oscillating over the border between adjacent keys. This method is not applicable if the notes are two or more semitones apart, such as Do and Re, or if they are one semitone apart but belong to two different octaves, such as 3Ti and 4Do. An annular trill zone 134 in the proximal part of the ring of note keys, delimited by circular border line 136 (FIG. 5A), provides the solution. FIG. 5B shows Do-Om activated by finger 130 (not shown for clarity) as evidenced by highlight 132, sounding note Do. The finger's touch contact point 138 is brought to the vicinity of Re. Point 138 then moves into the Re key, causing note Re to be sounded (FIG. 5C). Normally, Om would dissociate from Do and unite with Re. The presence of buffer zone 134, however, prevents this from happening, provided that point 138 does not penetrate past line 136. Since touchpoint 138 is still within zone 134, Re is only provisionally activated, as indicated by provisionally active pitch highlight 140. Point 138 then moves back into Om (FIG. 5D), again sounding note Do. Subsequent rapid oscillation of the finger between Om and Re delivers the desired Do-Re trill. The same technique can be applied for a trill involving, for example, 3Ti and 4Do, if the octave value is switched on the first entry of the second note's trill zone. More generally, this technique enables trilling using any two chosen notes within the tonal range of the instrument, i.e., the entire MIDI pitch space.

### Transposition

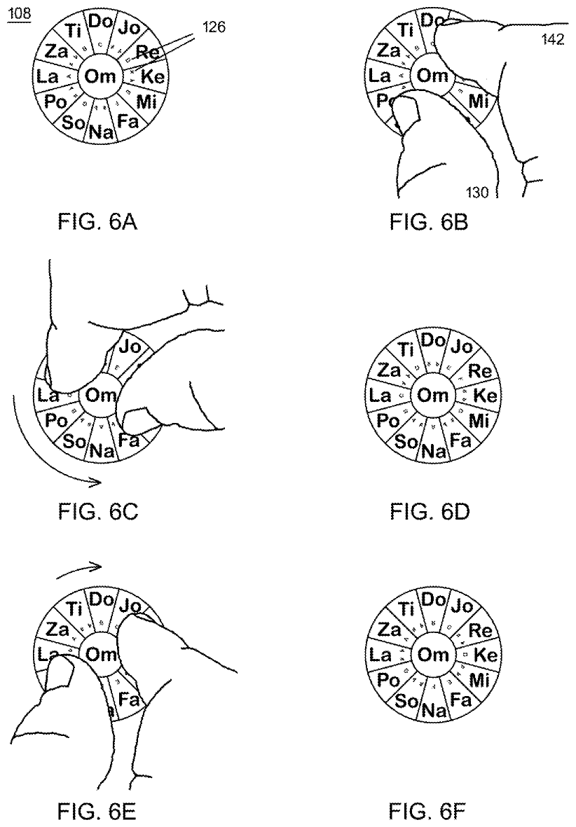

FIGS. 6A to 6F show the procedure for transposing, i.e., in this case changing the angular alignment between the moveable-Do solfege scale, Do-Jo-Re . . . , and the absolute-pitch letter-scale, C-C #-D . . . , for example in order to accommodate a singer's higher or lower voice register. In the default configuration (FIG. 6A), the circle of letter pitches 126 is angularly positioned so that C aligns with Do. Two fingers of the right hand, thumb 130 and index finger 142 are brought into contact with opposing keys So and Jo (FIG. 6B). Sensing the diametrically configured double touch, keypad 108 enters an adjustment mode which may be signaled visually. The fingers then rotate ninety degrees counterclockwise (FIG. 6C), turning the circle of pitch indicia 126 by the same angular displacement, bringing index D #into alignment with Do (FIG. 6D). A tune played with unchanged fingering pattern now sounds three semitones sharper. On the other hand, a rotation of thirty degrees in the clockwise direction from the initial position (FIG. 6E) flattens the pitch by one semitone, aligning B with Do (FIG. 6F).

### Scales

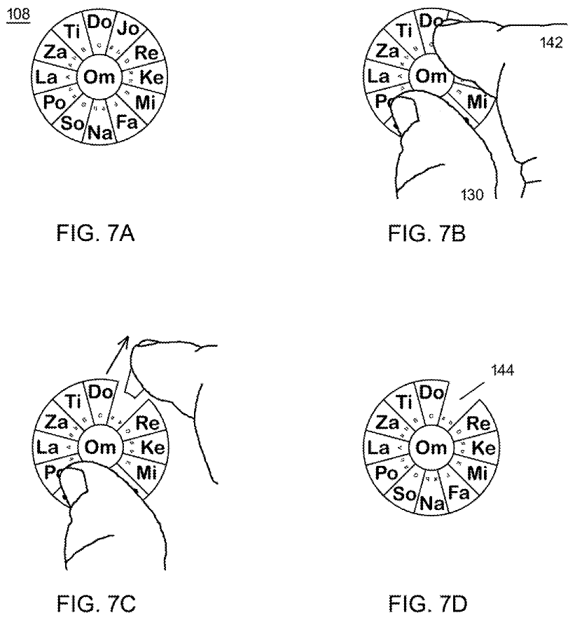

FIGS. 7A to 7D show the procedure for making a keyboard with fewer than the chromatic set of 12 keys, such as for producing a melody on a diatonic or a pentatonic scale. Starting from the default configuration with all keys present (FIG. 7A), fingers 130 and 142 establish a double-touch activation of an adjustment mode, as also happens at the initiation of transposition described above (FIG. 6B). Finger 142 then spreads the Jo key away (FIG. 7C), eliminating it from the keypad and leaving a key gap 144 (FIG. 7D). The reverse pinching maneuver would restore the key. Repeating the subtraction process leaves the desired reduced keypad.

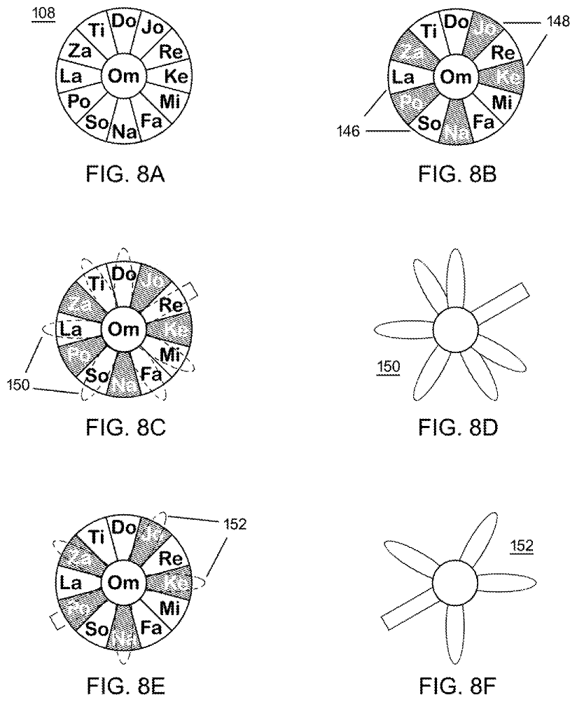

FIGS. 8A to 8F show the notional decomposition of the chromatic scale into two interdigitating scale structures, a diatonic scale structure and a pentatonic scale structure. The twelve keys in keypad 108 can be shown as seven white keys 146 and five black keys 148, as conventionally colored on a clavier (FIG. 8B). The diatonic scale structure 150 of the white notes is highlighted in FIG. 8C and diagrammed in FIG. 8D, and the pentatonic structure 152 of the black notes is highlighted in FIG. 8E and diagrammed in FIG. 8F.

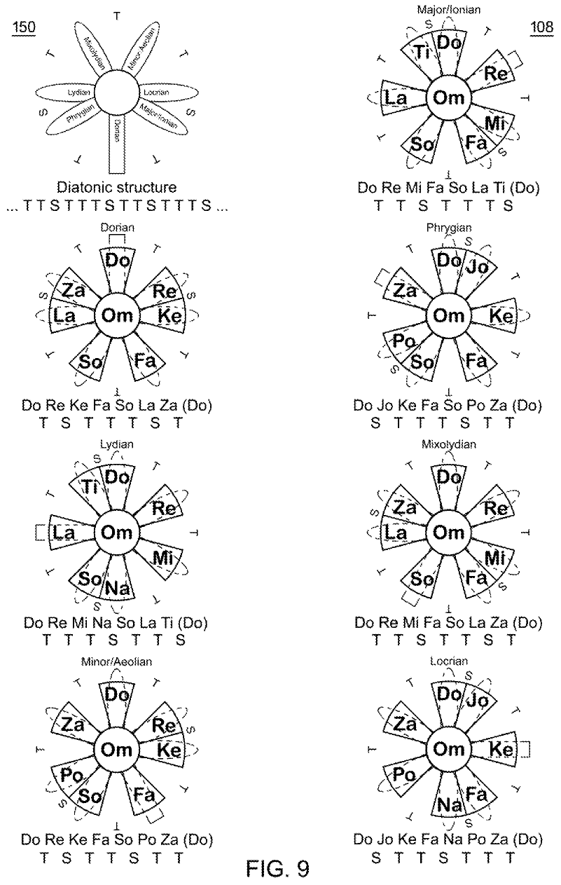

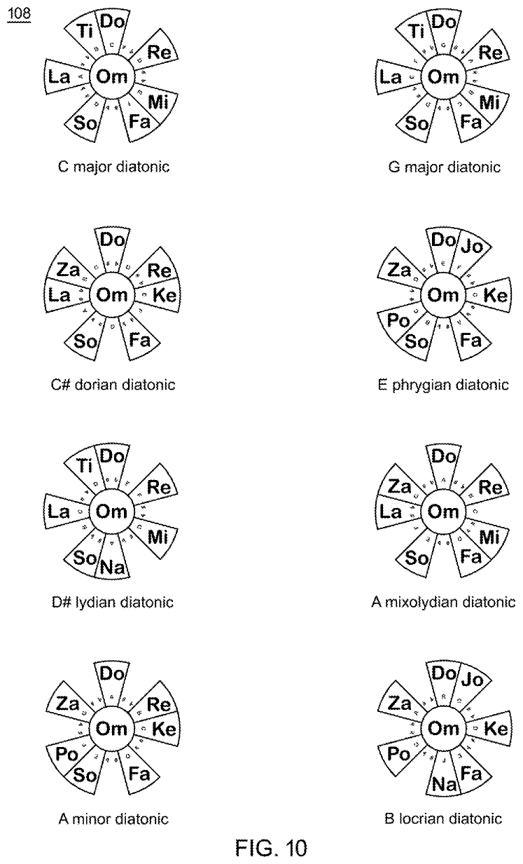

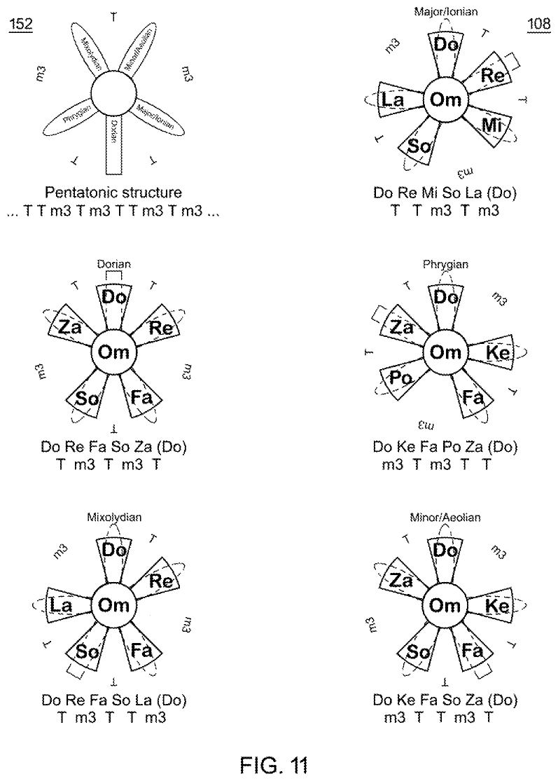

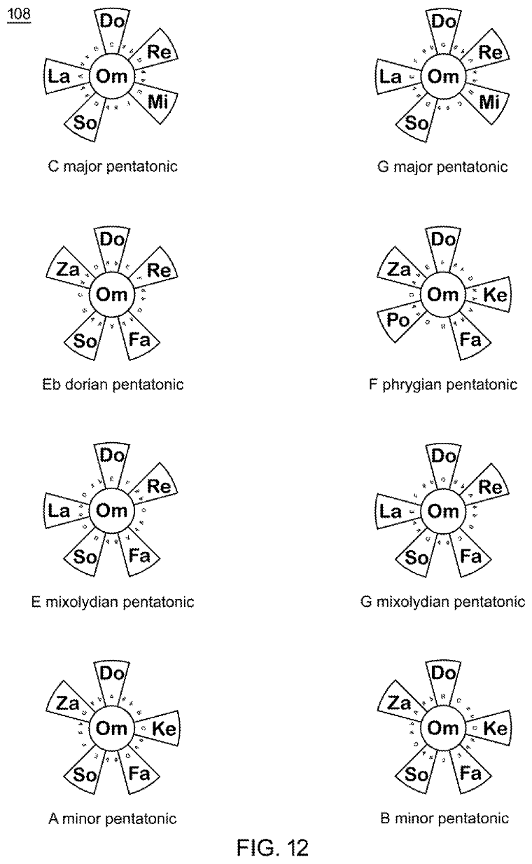

FIG. 9 shows details of diatonic scale structure 150 and its seven scale modes implemented on keypad 108 along with their interval sequences of tones (T) and semitones (S), such as TTSTTTS for the diatonic major/ionian mode. FIG. 10 shows a sampling of the eighty-four diatonic scale keys achievable through transposition of these seven diatonic scale modes. FIG. 11 shows details of the common pentatonic scale structure 152 and its five scale modes implemented on keypad 108 along with their interval sequences of tones (T) and minor thirds (m3), such as TTm3Tm3 for the pentatonic major/ionian mode. FIG. 12 shows representatives of the sixty pentatonic scale keys resulting from transposition of these modes. These processes of key subtraction and transposition applied to 12-TET yield its entire derivative set of 351 scale structures, 2,048 scale modes, and 24,576 scale keys as is known in the art.

### Musical Notation

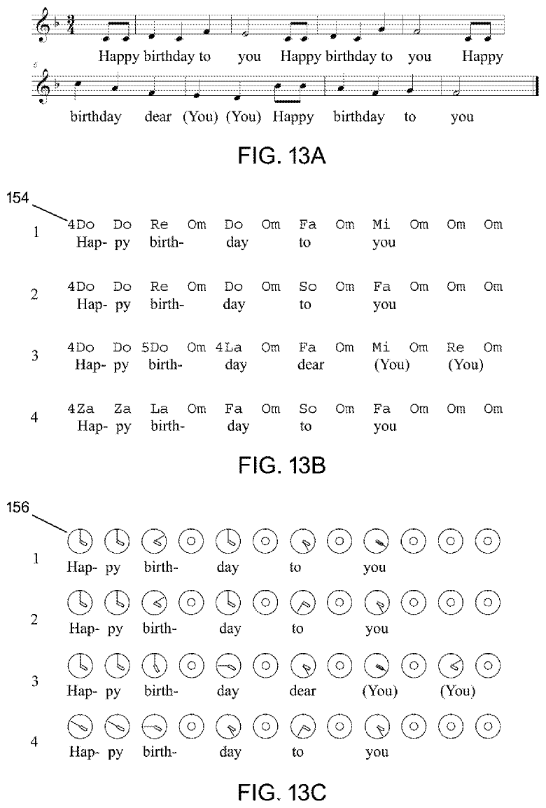

FIGS. 13A, 13B, and 13C show for comparison different forms of sheet music notation including the traditional staff-based system of the conventional music notation (FIG. 13A), the proposed simplified alphanumeric system (FIG. 13B), and the proposed pictographic system (FIG. 13C). The proposed alphanumeric and pictographic systems use discrete tokens representing individual notes. The alphanumeric system of FIG. 13B is both computer-readable and human-readable, using alphanumeric note representations, or note-word tokens, 154, comprising only ASCII characters easily typed on a handheld device for texting to a remote recipient. In recognition of Guido of Arezzo's contribution to the art, we may refer to note words 154 as guidotypes. Each guidotype 154, such as 4Do, comprises an octave specification, in this case 4, and a pitch specification, in this case Do. If the octave value has not changed from the previous note, then the octave specification is optional. Guidotype Hh means silence, and Om signifies note prolongation. Each guidotype represents a fixed length of time. The guidotype system provides a basic means for communicating simple melodic themes, less comprehensive than the existing GUIDO Music Notation, but sufficient to enable the average person to readily author and publish musical compositions through a music-sharing platform.

FIG. 13C shows a pictographic system that uses note-picture tokens, i.e., intuitive horomorphic diagrammatic symbols 156 detailed below. In recognition of Guido's contribution as well, we may refer to pictograms 156 as guidograms. The guidogram system serves as an instantly learnable universal musical sign language, requiring no prior knowledge of any alphabet or writing system. Inputting of logograms 156 can be facilitated by a specialized character set in a suitable encoding standard such as UTF-16. The present embodiment uses 130 guidograms 156, one for silence, Hh, one for note sustain, Om, and the rest for the 128 MIDI notes, identified by their solfege names. A conceivable extension of the system might accommodate trilling with double-note pictograms having two distinct sets of clock hands.

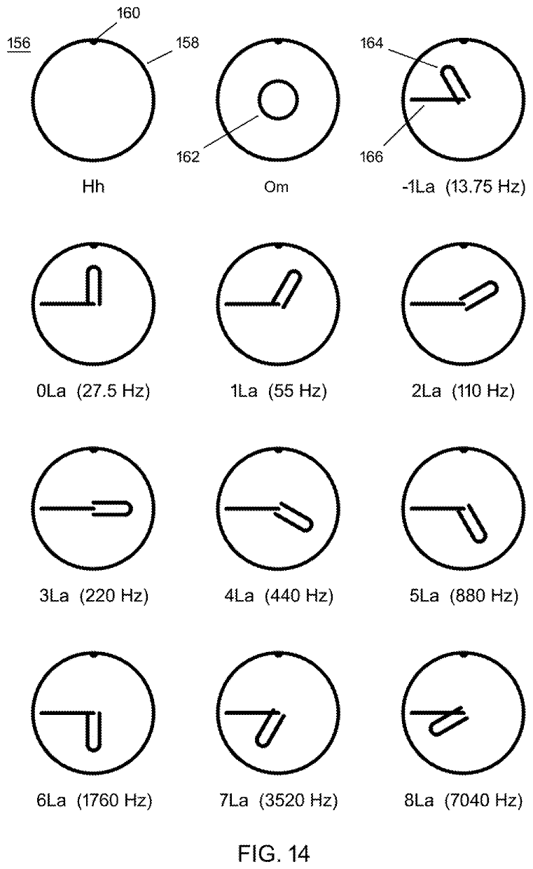

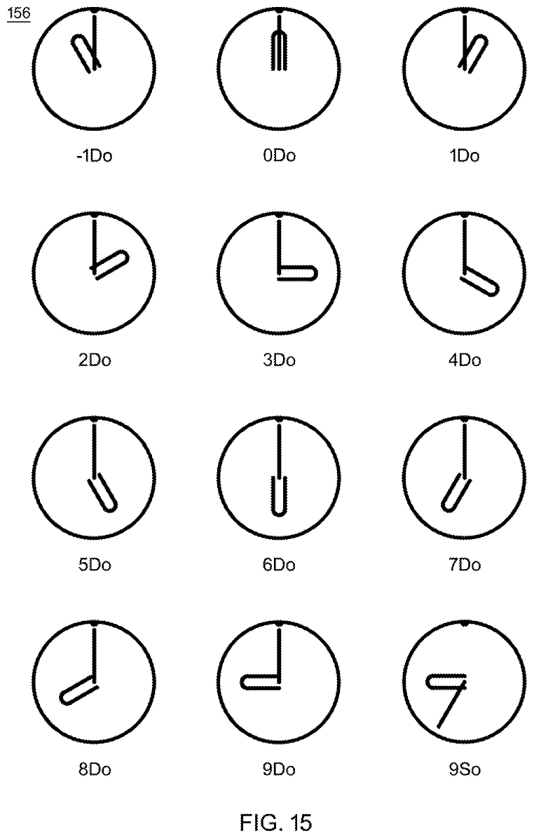

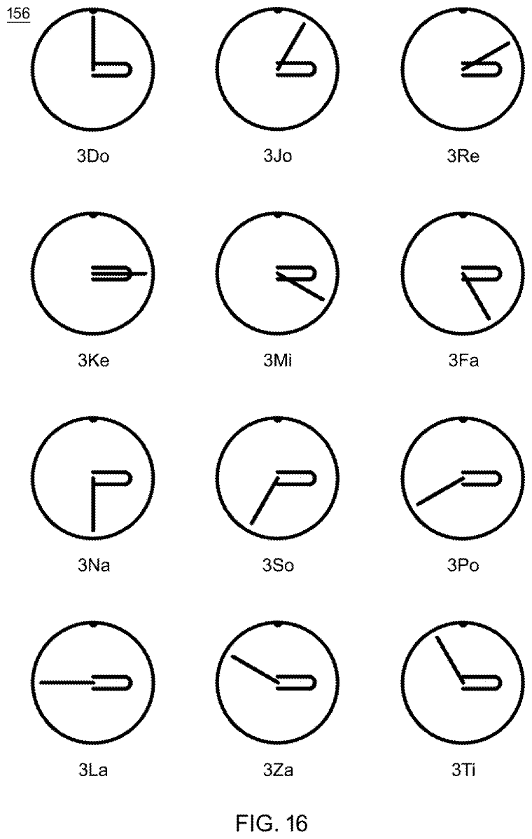

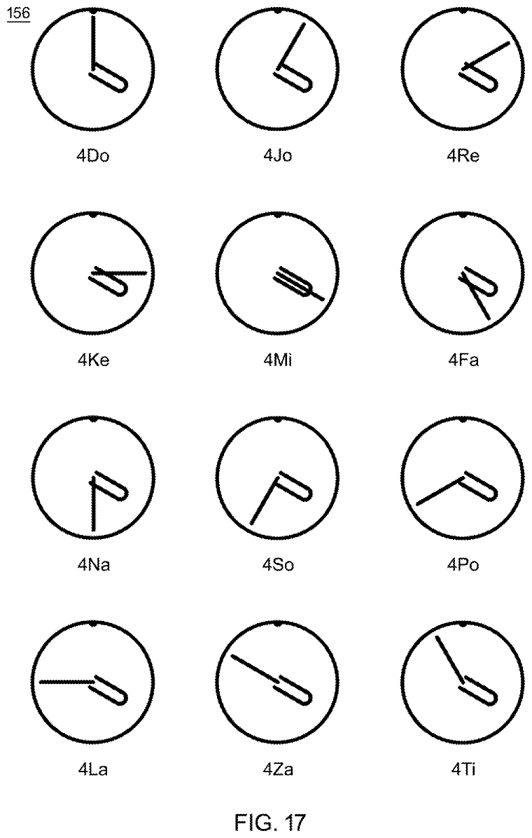

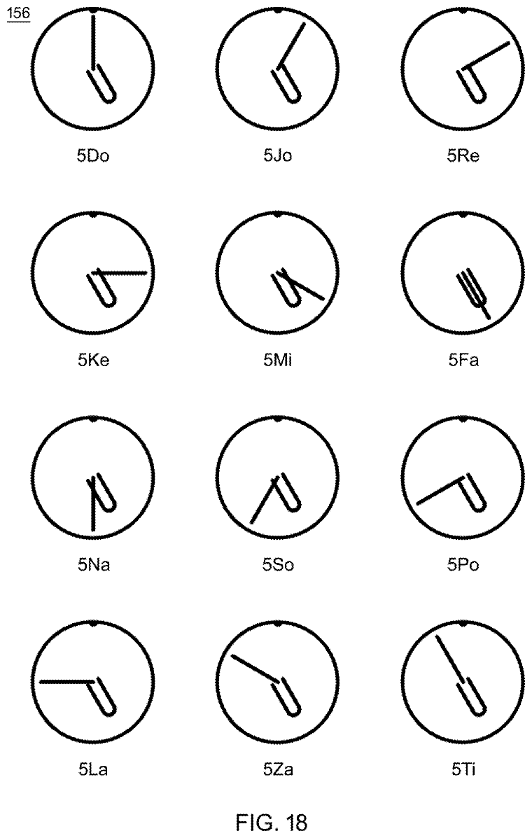

FIG. 14 shows selected guidotypes and their corresponding guidograms including Hh, Om, and the ten La pitches, from −1La to 8La along with their associated standard frequencies. A guidogram comprises a circular perimeter 158 and an index 160 marking the 12 o'clock position. Naturally, all twelve hour-position indication elements 160, or an intermediate reduced set, may be included. With a clear orientation context, index 160 may be omitted altogether. The silent guidogram or rest symbol has no additional markings. The Om guidogram includes a central Om sign 162. The note guidograms include a short octave indicator 164 shaped as a clockface hour hand and a long pitch indicator 166 similar to a minute hand. Unlike clock hands, indicators 164 and 166 do not adopt intermediate angles between the hour positions. If the octave value has not changed from the previous note, then the octave indicator may be omitted. FIG. 15 shows guidotypes and guidograms for the eleven Do pitches and the top So, spanning the MIDI range from −1Do to 9So. FIGS. 16, 17, and 18 respectively show guidotypes and guidograms for the notes of commonly used Octaves #3, #4, and #5. A guidotype and its equivalent guidogram are alternative representations of a note token that encodes octave and pitch class to identify a unique solfege note pitch. Note length is not specified for each note, and longer notes are generated using Om, the prolongation or sustain token. The absence of note length encoding in guidotypes 154 and guidograms 156 represents a departure from the norm set by other music notation systems but makes them simple and readily learnable.

Phone Embodiment with Additional Aspects

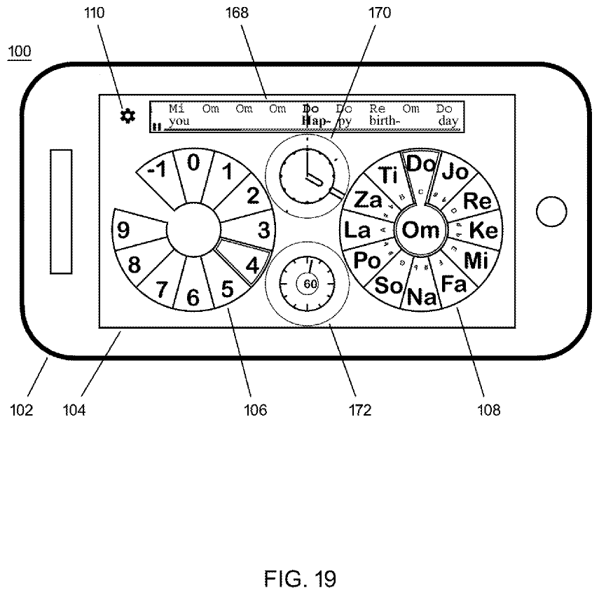

FIG. 19 shows phone embodiment 100 provided with additional features including a sheet music display 168, a note and piano roll display 170, and a tempo and rhythm display 172 aside from the previously discussed aspects.

### Sheet Music Display

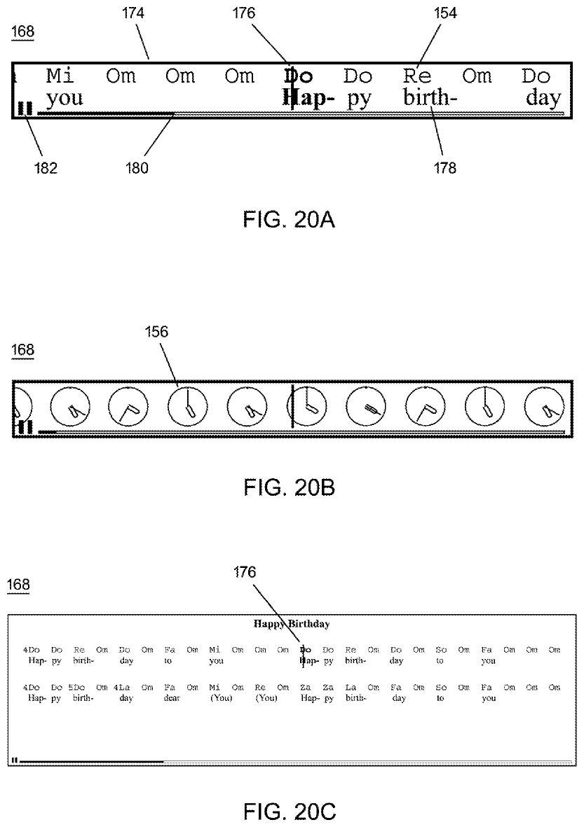

FIGS. 20A, 20B, and 20C show different configurations of sheet music display 168. FIG. 20A shows details of display 168 including a rectangular frame 174, a cursor 176, guidotypes 154, lyrics 178, a progress bar 180, and a play/pause button 182. In a display of this size, suitable for smartphone application, cursor 176 is stationary and the notes and lyrics scroll past in a ticker-tape fashion. In manual play mode, the user performs the music displayed by operating the octave and pitch keyboards. In karaoke mode, the device plays the notes and the user sings along. FIG. 20B shows an alternate configuration of display 168 using guidograms 156. FIG. 20C shows a tablet's larger-sized display 168 fitting a whole composition, allowing cursor 176 to become a dynamic visual indicator, acting as a moving visual mark over fixed note and lyric content. Sheet music content can be loaded into display 168 through direct typing or by cutting and pasting from an external source, such as a text message or a file downloaded from a shared repository on a social platform, creating new opportunities for amateur musicians and singers.

### Note and Piano Roll Display

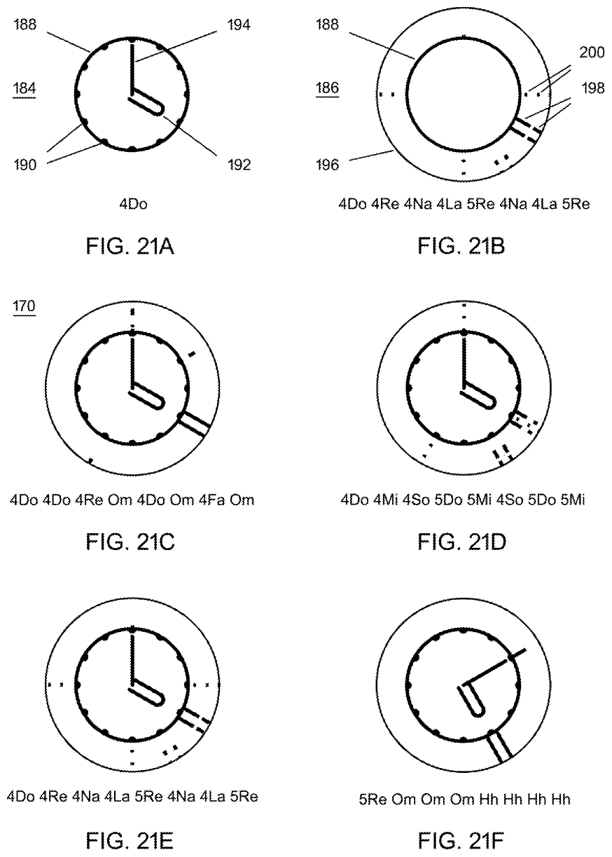

FIGS. 21A to 21F show details of note and piano roll display 170, which comprises a horomorphic note dial 184 (FIG. 21A) and a surrounding concentric piano roll ring 186 (FIG. 21B). FIG. 21A shows details of note dial 184 including a circular perimeter 188, indicia 190 disposed analogously to hour markings, a short hour hand-like octave indicator 192, and a long minute hand-like pitch indicator 194. Indicators 192 and 194 respond to the user's octave and pitch inputs made with keypads 106 and 108, providing an extra means of visual feedback indicating the note being played. FIG. 21B shows details of piano roll ring 186 including a circular perimeter 196, double-line octave graphic elements 198, and single-line pitch graphic elements 200. Dial perimeter 188 serves as the inner border of ring 186. Markings 198 and 200 are analogous to perforations in a traditional paper piano roll, but move in a radial, centripetal fashion from circle 196 to circle 188 to show upcoming notes for the performer to play. In an alternate teaching mode, indicators 192 and 194, and highlights 116 and 132 may be sequenced programmatically in conjunction with the piano roll for the student to follow with finger movements in producing the desired tune. In an alternate recording mode, elements 198 and 200 may radiate centrifugally to display the history of notes played. FIGS. 21C to 21F respectively show, as illustrative examples, display 170 exhibiting the first few piano roll notes of the Happy Birthday song, J. S. Bach's Prelude in C major, another excerpt of that piece, and the corresponding flute part of Gounod's Ave Maria adaptation of same. Guidogram 156 and note dial 184 being homomorphic, a user without reading ability can play a piece by simply positioning the fingers to mimic the placement of the guidogram indicators in display 168 with immediate visual feedback provided by neighboring dial 184.

The above embodiments provide the elements for a novel music teaching and learning method based on an all-horomorphic paradigm. Keypads 106 and 108 constitute a horomorphic manual for the keyboard instrument. Display 168 can provide horomorphic sheet music and display 170 supplies a horomorphic note visual. A student may practice eye-hand-ear-mouth coordination by reading the horomorphic notation, playing the horomorphic manual, observing the horomorphic note display, hearing the solfege rendition, and singing solfege in unison with it, thereby simultaneously learning singing and instrument playing at an enhanced rate in a symbiotic pedagogic loop.

### Tempo and Rhythm Display

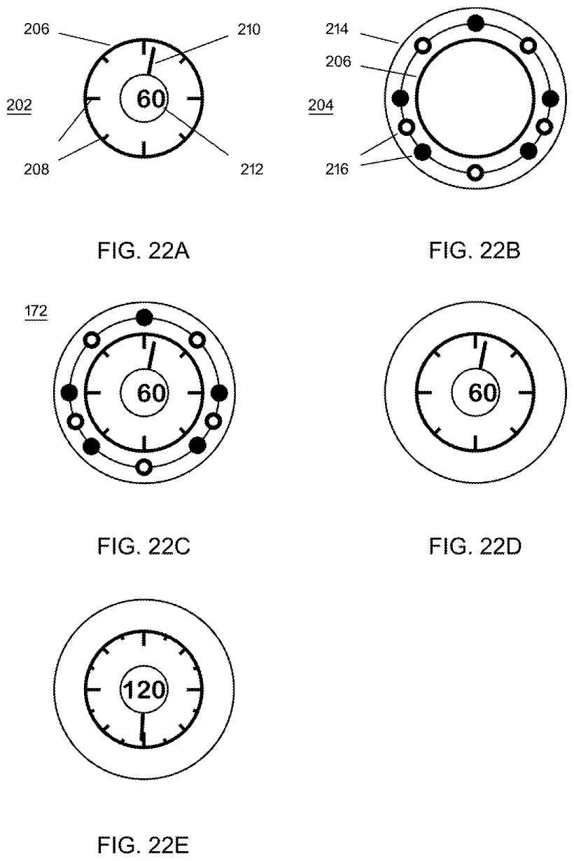

FIGS. 22A to 22E show details of tempo and rhythm display 172, which comprises a tempo or metronome dial 202 (FIG. 22A) and a surrounding concentric rhythm or percussion ring 204 (FIG. 22B). FIG. 22A shows details of tempo dial 202 including a circular perimeter 206, indicia 208 marking time steps as an indicator or hand 210 rotates clockwise at a rate indicated by a tempo readout 212, in this illustration set at 60 bpm. The speed of hand 210 and the number of markings 208 correspond to the scrolling pace and phrasing organization in display 168. FIG. 22B shows details of rhythm ring 204 including a circular perimeter 214 and percussion indicia 216 indicating the automatic production of programmable sounds such as drum and snare as hand 210 sweeps by. Dial perimeter 206 serves as the inner border of ring 204. FIG. 22C shows tempo and rhythm display 172 with both metronome 202 and percussion 204 active. As a further illustrative example, the metronome alone is active and adjusted to 60 bpm with eight time divisions in FIG. 22D, and 120 bpm with sixteen divisions in FIG. 22E.

### Large Screen

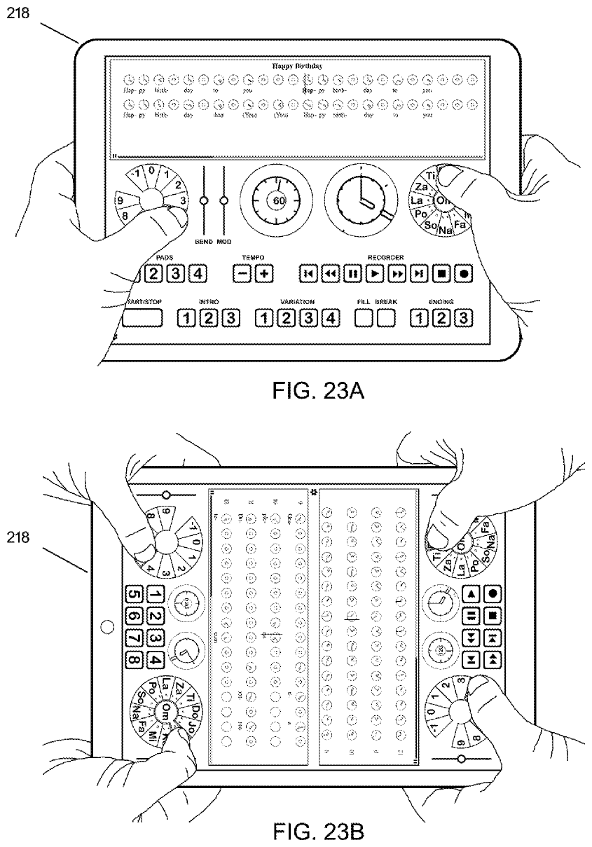

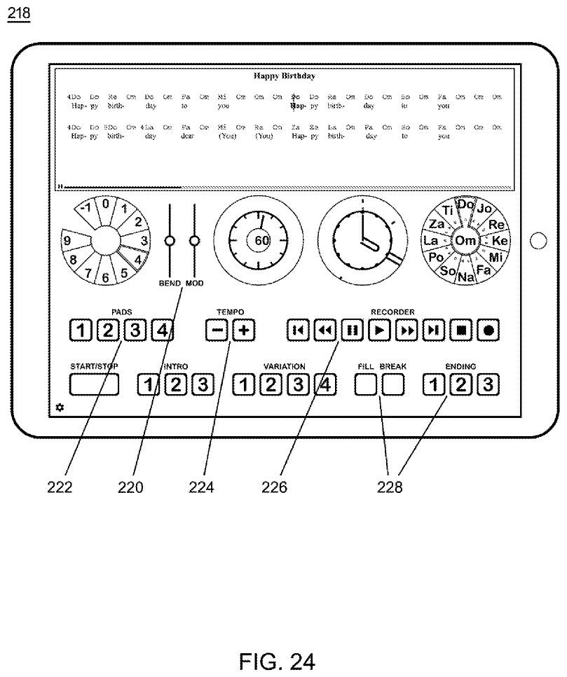

FIGS. 23A and 23B respectively show a tablet-based embodiment 218 configured for single-operator and tandem multiplayer operation for songs with multiple instrument parts. FIG. 24 details the additional features accommodated by the large screen of tablet 218, as customarily provided in a typical electronic keyboard or in a musical keyboard app running on a tablet, including bend and modulation sliders 220, pad buttons 222, tempo adjustments 224, recorder controls 226, and an automatic accompaniment section 228.

### Small Screen

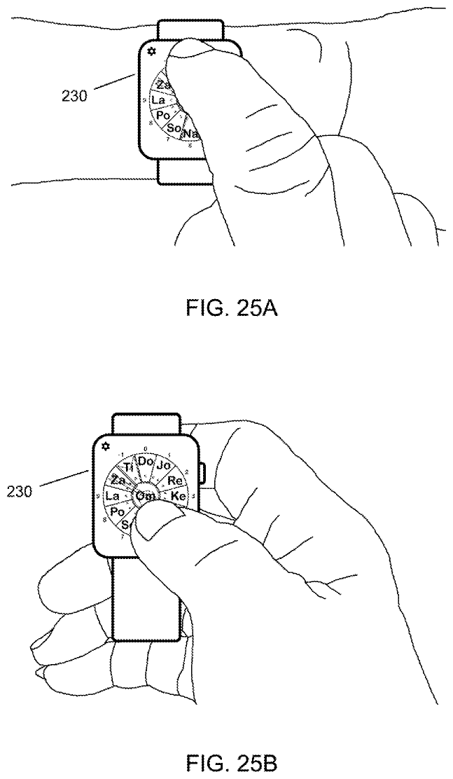

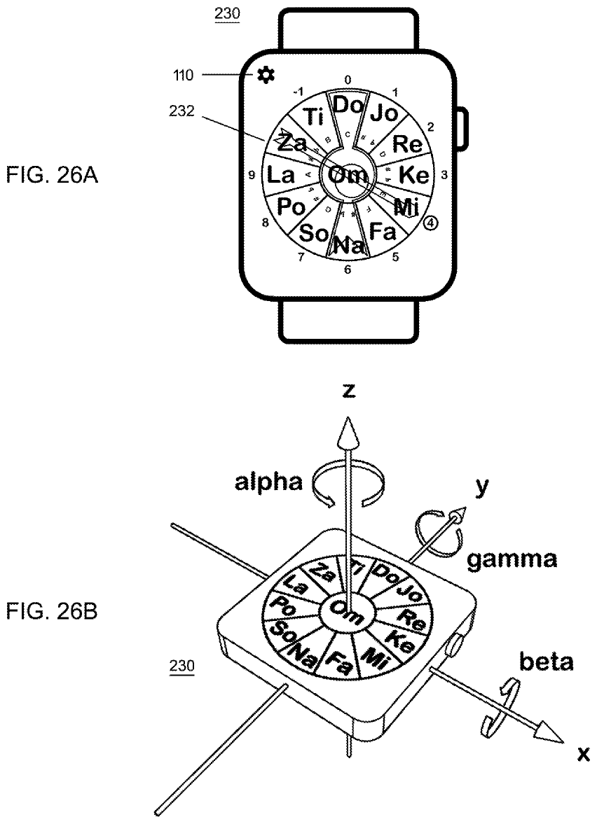

FIG. 25A shows a watch-based embodiment 230 worn on the user's left wrist and played with the right index finger. FIG. 25B shows watch 230 in single-handed operation, played with the thumb. FIG. 26A shows the small screen of device 230 accommodating, aside from settings button 110, only a combination octave and pitch selection keypad 232 that constitutes an augmented form of keypad 108 providing visual feedback for octave selection in collaboration with the built-in inertial sensors of device 230. FIG. 26B shows a reference system attached to the body of watch 230 including orthogonal axes x, y, and z defining planes xy, yz, and zx, and rotations alpha, beta, and gamma. For a watch equipped with accelerometers and gyroscopes, all linear and rotational movements can be detected. For a watch equipped with accelerometers but no gyroscopes, all but rotation alpha can be detected when the device is operated in a substantially horizontal posture within a gravitational field. This provides sufficient attitude data for adequate functionality.

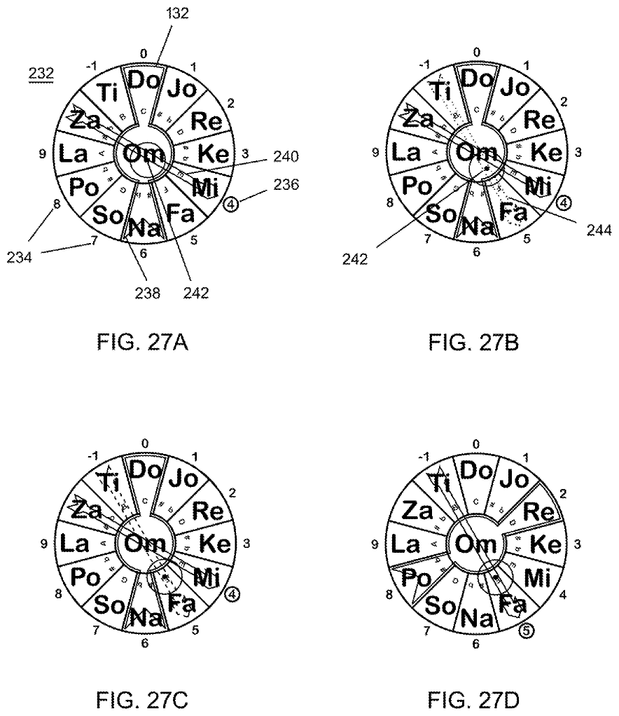

FIGS. 27A to 27D show how octave selection is performed through the tilting of device 230 with visual feedback provided in keypad 232. FIG. 27A shows the details of keypad 232 including peripheral octave indicia 234 and a peripheral active octave highlight 236. Octave selection is done through the tilting of device 230 in the direction of the desired octave index 234. Active pitch highlight 132 is extended with a counterpointing supplemental highlight 238 for enhanced visibility. An arrow-shaped octave pointer or indicator 240 and a level indicator 242 provide visual feedback for the user's tilting maneuver when switching octaves, guided by indicia 234 and highlight 236. FIGS. 27B to 27D show a transition process from Octave #4 to Octave #5 as note Do gives way to note Re. For clarity, the playing finger and its contact point are not shown. FIG. 27B shows the Do key active, sounding note 4Do. The device is slightly tilted toward the Octave #5 index, and the level indicator approaches Fa. A pending octave pointer or indicator 244 appears faintly, pointing in the new direction, signifying an impending octave switch. FIG. 27C shows the device then definitely tilted toward Octave #5, the level indicator lying within the confines of the Fa key. The appearance of pointer 244 is now more pronounced, signifying a committed octave switch that will take effect when a new pitch is selected. FIG. 27D shows pitch Re now played, with octave value “5” applied, with highlight 236 now centered on the #5 indicium. The user thus switched from 4Do to 5Re by tilting the device just before switching notes. Here again, haptic feedback may assist in the return to level state.

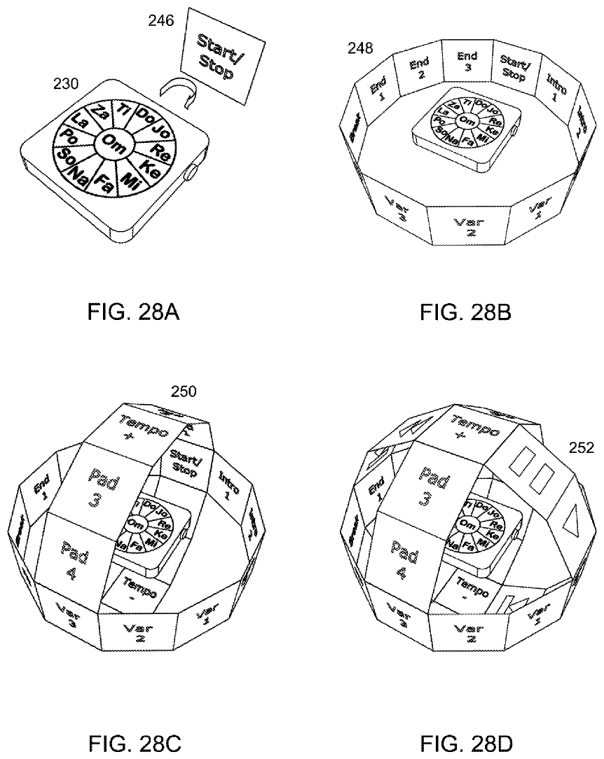

FIGS. 28A to 28D show how the inertial sensors of watch 230 can also be leveraged to attain a level of functionality comparable to that afforded by the larger screen of tablet 218. FIG. 28A shows device 230 undergoing a rapid to-and-fro jabbing motion in the y direction toward an imaginary target, virtual button 246, triggering the corresponding action. Additional motion-controlled triggers can be disposed in a virtual 12-button ring 248 in the xy plane (FIG. 28B), a 10-button partial ring 250 in the yz plane (FIG. 28C), and an 8-button partial ring 252 in the zx plane (FIG. 28D) for a total of thirty readily targetable virtual sensing sites, with residual availability in the eight intervening sectors. Slow translation along the principal axes as well as intermediate directions can be mapped to slider controls. In a microgravity or zero-gravity situation, virtual buttons 246 can be used for octave selection if watch 230 has accelerometers but no gyroscopes. All inertial maneuvers described above can be used with phone 100 as well, similarly enabling one-handed operation and access to extended functions during play.

### CONCLUSION, RAMIFICATIONS, AND SCOPE

The embodiments provide a universal musical method accessible to the average person in possession of a portable smart device. The system is affordable and easy to use for performing, creating, and sharing music. Although the description above contains many specificities, these should not be construed as limiting the scope of the embodiments but as merely providing illustrations of some of several embodiments. For example, the standard frequency for 4La may be set to 432 Hz or another value; the scale tuning may be meantone or just; the keys may be colored in a rainbow pattern; the instrument may be built as a physical keyboard with moveable keys, etc. Thus, the scope of the embodiments should be determined by the appended claims and their legal equivalents, rather than by the examples given.

I claim:

1. A 12-tone monophonic keyboard musical instrument comprising:
a) An octave selection means for selecting the octave property of a note;
b) A pitch selection means for selecting the pitch class property of a note, said pitch selection means comprising twelve peripheral keys, said keys being activatable one at a time, said keys being arranged in a clockface-like annular pattern enclosing a centrally-positioned key, said central key being configured to switch identity and become the temporary functional extension of any peripheral key being activated, such that a finger selecting a given peripheral key may return to the central position while maintaining continuous activation of the corresponding musical note;
c) An electronic means for processing the input of said octave selection means and said pitch selection means and producing a sound according to said octave property and said pitch class property;
whereby a player may effect the smooth monophonic performance of a melody without acoustic discontinuity from one note to the next.

2. The device of claim 1 wherein said octave selection means includes a plurality of radio buttons arranged in a horomorphic pattern.

3. The device of claim 1 provided with an option selection means for selecting musical functions and properties including envelope and timbre.

4. The device of claim 1 wherein each one of said keys is assigned a unique monosyllabic name and is configured to sing in a human voice said name when activated, at its associated pitch.

5. The device of claim 4 wherein said names are Do, Jo, Re, Ke, Mi, Fa, Na, So, Po, La, Za, and Ti.

6. The device of claim 1 provided with haptic feedback to assist positioning of a playing finger.

7. The device of claim 1 wherein the proximal margin of said annular pattern does not cause said central key to switch identity, thereby enabling trilling.

8. The device of claim 1 provided with a means for shifting the absolute pitch scale relative to said keys, thereby enabling musical transposition.

9. The device of claim 1 provided with a means for removing selected keys, thereby providing for the construction of scales with a reduced set of keys.

10. The device of claim 1 provided with a sheet music display.

11. The device of claim 1 provided with a horomorphic note display.

12. The device of claim 1 provided with a piano roll display.

13. The device of claim 1 provided with a tempo and rhythm display.

14. The device of claim 1 provided with sound effects, automatic accompaniment, and recording functions.

15. The device of claim 1 wherein said octave selection means includes circularly arranged octave indicia and octave selection is effected through the tilting motion of said device in the direction of a desired one of said octave indicia.

16. The device of claim 1 provided with a plurality of virtual buttons for selecting optional functions, each virtual button being activated through a jabbing motion of said device in the direction of said button.

17. A music notation system wherein each note is indicated by a discrete token, said token representing a fixed time duration, said token being selected from the group consisting of a silence token, a continuation token, and a pitch token, said pitch token comprising an octave indication specifying an octave value and a pitch class indication specifying a pitch class value, said octave indication being optional if said octave value is identical to the octave value of the immediately preceding note when said preceding note exists;
whereby the notes of a melodic musical composition may be represented by a sequence of separate symbols easily created, manipulated, and transmitted using a personal electronic device.

18. The system of claim 17 wherein said token is an alphanumeric word, said silence token is the word “Hh”, said continuation token is the word “Om”, said octave indication is a numeral, and said pitch class indication is a two-letter solfege name.

19. The system of claim 17 wherein said token is a horomorphic pictogram, said silence token is a horomorphic pictogram without hands, said continuation token is a horomorphic pictogram without hands provided with a central circle, and said pitch token is a horomorphic pictogram wherein the short hand serves as said octave indication and the long hand serves as said pitch class indication.

20. A music teaching and learning method comprising:
a) Providing a musical keyboard instrument with a horomorphic manual adapted to produce a musical solfege rendition in unambiguous, monosyllabic solfege vocals in a human-like voice;
b) Providing a horomorphic note display in close visual proximity to said manual;
c) Providing a sheet music display showing sheet music in horomorphic notation in close visual proximity to said manual and said note display;
whereby a student may practice eye-hand-ear-mouth coordination by reading said horomorphic notation, playing said horomorphic manual, observing said horomorphic note display, hearing said solfege rendition, and singing solfege in unison with said solfege rendition, thereby simultaneously learning singing and instrument playing at an enhanced rate in a symbiotic pedagogic loop.
